(19) United States
(12) Patent Application Publication
(10) Pub. No.: US 2026/0340931 A1
(43) Pub. Date: Oct. 29, 2026

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: HIROKI WATABE, Tokyo (JP)

(21) Appl. No.: 19/638,915

(22) Filed: Apr. 3, 2026

(30) Foreign Application Priority Data
Apr. 25, 2025 (JP) 2025-073256

(51) Int. Cl. G06T 15/20; G06T 7/73; G06T 7/90; G06T 19/20

(52) U.S. Cl. CPC G06T 15/20; G06T 7/73; G06T 7/90; G06T 19/20; G06T 2207/10024; G06T 2219/2021

(57) ABSTRACT

One or more image processing apparatuses, methods, and storage mediums are provided herein. A mesh including a plurality of polygons each having pixels of a rendered image as vertices is generated, and, in accordance with the reprojection processing, the generated mesh is deformed based on a depth image and motion information. Then, distances from the viewpoint to vertices of a respective polygon of the plurality of polygons of the deformed mesh are determined, and a color for each pixel inside the respective polygon is determined based on a color of a vertex having the greatest distance from the viewpoint among vertices of the respective polygon.

### BACKGROUND

### Field of the Technology

The present disclosure relates to one or more embodiments of image processing apparatuses, image processing methods, and storage mediums.

### Description of the Related Art

Typically, a head-mounted display (HMD) is used as a device for experiencing virtual reality (VR) content. By rendering and displaying computer-generated graphics (CG) images of virtual objects in accordance with a user's position and orientation while the user wears the HMD, such a device can provide the user with an experience as if the user were moving within a virtual space.

When an image is rendered in accordance with the position and orientation of the user, a latency occurs between rendering the image and displaying the image. As a result, misalignment can arise between the position and orientation used for rendering and the position and orientation of the user at the time of display, which may cause the user to feel motion sickness.

To address this, processing called “Timewarp” may be performed to correct such misalignment in the position and orientation by performing reprojection processing on a rendered image based on the latest position and orientation. In addition, VR content often requires a high-frame-rate experience. To address this, processing called “Spacewarp” may be performed to generate a pseudo high-frame-rate image by performing reprojection processing on a low-frame-rate image based on motion vectors of CG.

In contrast, in a case where a plurality of CG objects overlap, performing such reprojection processing may cause holes. For example, when reprojection processing is performed such that an image rendered from a certain viewpoint appears as an image viewed from another viewpoint, no source image data is available in a region that was not visible before the reprojection, and thus a hole is generated in the region. As a method for addressing such a hole region, Japanese Patent Laid-Open No. 2021-15372 describes a technique in which reprojection processing is performed using a result of previous reprojection processing as an initial value. In addition, a technique has also been described in which a polygon mesh is formed with each pixel being treated as a vertex and reprojection processing is performed on a per-polygon basis.

### SUMMARY

According to one or more aspects of the present disclosure, at least one embodiment of an image processing apparatus may perform reprojection processing on a rendered image obtained by rendering an image of a virtual object, to correct a positional misalignment based on a depth image in which a depth value representing a distance from a viewpoint in the rendered image is embedded and based on motion information at the viewpoint, and at least one embodiment of the image processing apparatus may include one or more processors that operate to: generate a mesh including a plurality of polygons each having pixels of the rendered image as vertices; deform, in accordance with the reprojection processing, the generated mesh based on the depth image and the motion information; determine, for each vertex of a respective polygon of the plurality of polygons of the deformed mesh, a distance from the viewpoint to the vertex; and determine a color for each pixel inside a respective polygon of the plurality of polygons of the deformed mesh, based on the determined distances from the viewpoint to vertices of the respective polygon.

According to other aspects of the present disclosure, one or more additional image processing apparatuses, one or more image processing methods, and one or more storage mediums are discussed herein. Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating at least one embodiment example of a configuration of an image display system in accordance with one or more aspects of the present disclosure.

FIG. 2 is a block diagram illustrating at least one embodiment example of a hardware configuration of an image processing apparatus in accordance with one or more aspects of the present disclosure.

FIG. 3 is a block diagram illustrating at least one embodiment example of a functional configuration of an image processing apparatus in accordance with one or more aspects of the present disclosure.

FIG. 4 is a flowchart illustrating at least one embodiment example of an overall processing procedure performed by an image processing apparatus in accordance with one or more aspects of the present disclosure.

FIGS. 5A and 5B are diagrams illustrating an outline of at least one embodiment of typical reprojection processing performed based on the latest position and orientation in accordance with one or more aspects of the present disclosure.

FIGS. 6A to 6C are diagrams illustrating an outline of at least one embodiment of a method for determining a color inside a mesh in accordance with one or more aspects of the present disclosure.

FIG. 7 is a flowchart illustrating at least one embodiment example of a detailed processing procedure of reprojection processing in accordance with one or more aspects of the present disclosure.

FIGS. 8A to 8D are diagrams illustrating at least one embodiment of a method for generating polygons and a mesh in accordance with one or more aspects of the present disclosure.

FIGS. 9A and 9B are diagrams illustrating at least one embodiment example in which a translucent object is moved through reprojection processing in accordance with one or more aspects of the present disclosure.

FIG. 10 is a block diagram illustrating at least one embodiment example of a functional configuration of an image processing apparatus in accordance with one or more aspects of the present disclosure.

FIG. 11 is a flowchart illustrating at least one embodiment example of a detailed processing procedure of reprojection processing in accordance with one or more aspects of the present disclosure.

FIGS. 12A to 12C are diagrams illustrating an outline of at least one embodiment of another method for determining a color inside a mesh in accordance with one or more aspects of the present disclosure.

### DESCRIPTION OF THE EMBODIMENTS

Embodiments of the present disclosure will be described below with reference to the accompanying drawings. The present disclosure is not limited to the embodiments described below, and various forms within the scope that does not depart from the gist of the present disclosure are also included in the present disclosure. Further, each of the embodiments described below merely illustrates an embodiment of the present disclosure, and embodiments may also be combined as appropriate.

In a technique that performs reprojection processing on a per-polygon basis, for hole regions generated by performing reprojection processing in a state where a plurality of computer-generated graphics (CG) objects overlap, pixel colors are determined by linear interpolation using colors of vertex pixels constituting a polygon mesh. However, linear interpolation may cause gradation-like artifacts in the interpolated regions.

One or more features of the present disclosure are directed to reducing the occurrence of gradation-like artifacts resulting from reprojection processing that corrects a positional misalignment in a rendered image.

### One or More Embodiments

In one or more embodiments, at least one example will be described in which, among vertices constituting a polygon, a vertex located farthest from a viewpoint is obtained and processing is performed to determine a color inside the polygon based on the color of the vertex.

### (Image Display System Configuration(s) for One or More Embodiments)

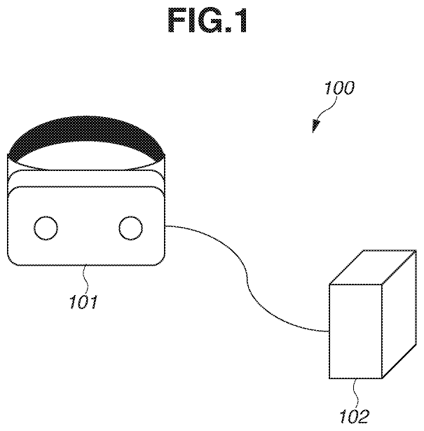

FIG. 1 is a diagram illustrating at least one embodiment example of a configuration of an image display system 100 in accordance with one or more aspects of the present disclosure. As illustrated in FIG. 1, the image display system 100 includes a head-mounted display (HMD) 101 and an image processing apparatus 102. The HMD 101 and the image processing apparatus 102 are connected to each other via a video signal line, such as a High-Definition Multimedia Interface (HDMI®) cable, and a data signal line, such as a Universal Serial Bus (USB) cable, to communicate image data, control signals, and the like. Further, to receive an input from a user, an input device, such as an unillustrated controller or keyboard, is connected to the image processing apparatus 102 via a wired connection, such as a USB cable, or a wireless connection, such as Bluetooth®.

In one or more embodiments, the image processing apparatus 102 is described as being independent of the HMD 101. However, the image processing apparatus 102 may be incorporated in the HMD 101 as an integrated HMD system.

### (Hardware Configuration(s) of One or More Image Processing Apparatuses)

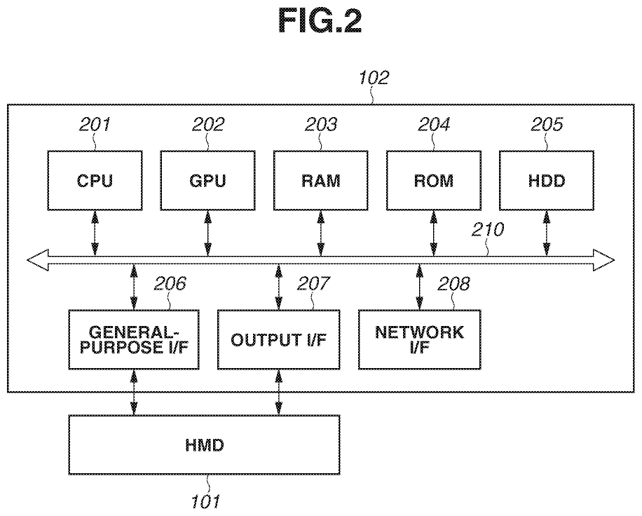

FIG. 2 is a block diagram illustrating at least one embodiment example of a hardware configuration of the image processing apparatus 102 in accordance with one or more aspects of the present disclosure. A central processing unit (CPU) 201 is a processor that comprehensively controls the components in the image processing apparatus 102. A graphics processing unit (GPU) 202 performs rendering of computer-generated graphics (CG) in response to an instruction from the CPU 201 and generates a display image to be displayed on the HMD 101. A random-access memory (RAM) 203 functions as a main memory, a work area, and the like for the CPU 201. A read-only memory (ROM) 204 stores programs to be executed by the CPU 201. A hard disk drive (HDD) 205 stores an application to be executed by the CPU 201, data used for image processing, and the like.

A general-purpose interface (I/F) 206 is a serial bus interface, such as USB or Institute of Electrical and Electronics Engineers (IEEE) 1394, and is connected to an inertial measurement unit (IMU) and/or a distance sensor provided in the HMD 101. This enables acquisition, from the HMD 101, of position and orientation information and a depth value to a real object, and the like. An output I/F 207 is an interface, such as HDMI or DisplayPort, and is used to cause a display of the HMD 101 to display a display image. A network I/F 208 performs communication via a network, such as a local area network (LAN) or the Internet, under control of the CPU 201. A system bus 210 manages data flow in the apparatus.

The image processing apparatus 102 may include components other than those described above and is not limited to the configuration illustrated in FIG. 2.

### (Functional Configuration(s) of One or More Image Processing Apparatuses)

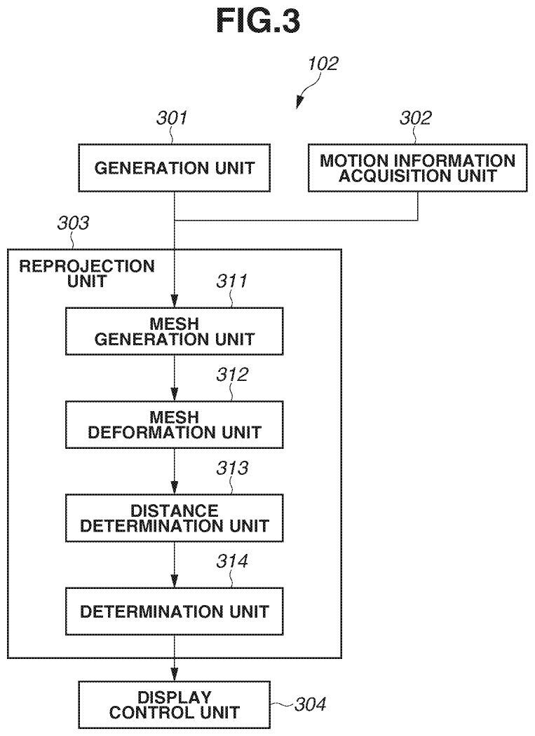

FIG. 3 is a block diagram illustrating at least one embodiment example of a functional configuration of the image processing apparatus 102 in accordance with one or more aspects of the present disclosure. The image processing apparatus 102 includes a generation unit 301, a motion information acquisition unit 302, a reprojection unit 303, and a display control unit 304. The reprojection unit 303 includes a mesh generation unit 311, a mesh deformation unit 312, a distance determination unit 313, and a determination unit 314.

The generation unit 301 renders, based on the position and orientation information acquired from the HMD 101, an image of a CG virtual object to generate a rendered image and also generates, for each rendered image, a depth image in which depth values representing distances in a depth direction from a viewpoint are embedded. The motion information acquisition unit 302 acquires motion information to be used for reprojection processing.

The reprojection unit 303 performs reprojection processing on a rendered image generated by the generation unit 301 based on the motion information acquired by the motion information acquisition unit 302. The reprojection unit 303 performs the reprojection processing through the processes described below.

The mesh generation unit 311 generates a mesh based on a rendered image generated by the generation unit 301. The mesh deformation unit 312 deforms the mesh generated by the mesh generation unit 311 based on the motion information acquired by the motion information acquisition unit 302. The distance determination unit 313 determines a distance from a viewpoint for each vertex of the polygons constituting the mesh deformed by the mesh deformation unit 312. The determination unit 314 determines a color inside the polygon based on the distance determined by the distance determination unit 313. Details of these processes will be described below.

The display control unit 304 transmits a rendered image to which reprojection processing has been applied to the HMD 101 via the output I/F 207, and displays the rendered image on the display of the HMD 101.

### (Processing Executed by the One or More Image Processing Apparatuses)

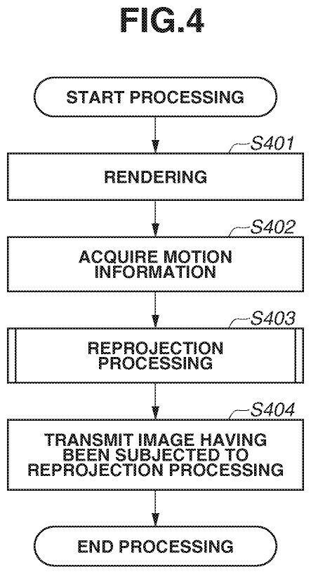

FIG. 4 is a flowchart illustrating at least one embodiment example of an overall processing procedure performed by the image processing apparatus 102 in accordance with one or more aspects of the present disclosure. An overall flow of processing executed by the image processing apparatus 102 according to one or more embodiments will be described below with reference to FIG. 4. The processing illustrated in FIG. 4 represents a processing flow for each frame for one or more embodiments, and by repeatedly executing this processing for each frame, the HMD 101 may display a moving image as video.

In step S401, the generation unit 301 renders an image of a CG virtual object based on position and orientation information acquired from the HMD 101, and generates a rendered image and a depth image. In generating the rendered image, the generation unit 301 stores the position and orientation information acquired from the HMD 101 in association with the rendered image.

Next, in step S402, the motion information acquisition unit 302 acquires motion information to be used in the reprojection processing. Here, the motion information relates to movement of the HMD 101 or the CG. In one or more embodiments, the motion information acquisition unit 302 acquires position and orientation information of the HMD 101 as the motion information. To acquire the position and orientation information of the HMD 101, the motion information acquisition unit 302 acquires two pieces of position and orientation information, namely, the position and orientation information used for rendering in step S401 and the latest position and orientation information immediately before performing the reprojection processing, which is newer than the position and orientation information used at a time of generating the rendered image. The position and orientation information used for rendering is stored in association with the rendered image, and the motion information acquisition unit 302 acquires the position and orientation information. The motion information acquisition unit 302 requests the latest position and orientation information from the HMD 101 to acquire the latest position and orientation information immediately before performing the reprojection processing. A method for acquiring the position and orientation information is not limited to this method.

Next, in step S403, the reprojection unit 303 performs reprojection processing on the rendered image generated in step S401. Details of this operation will be described below.

In step S404, the display control unit 304 transmits, to the HMD 101, the rendered image on which the reprojection processing has been performed in step S403.

### (Details of Reprojection Processing in Step S403 for One or More Embodiments)

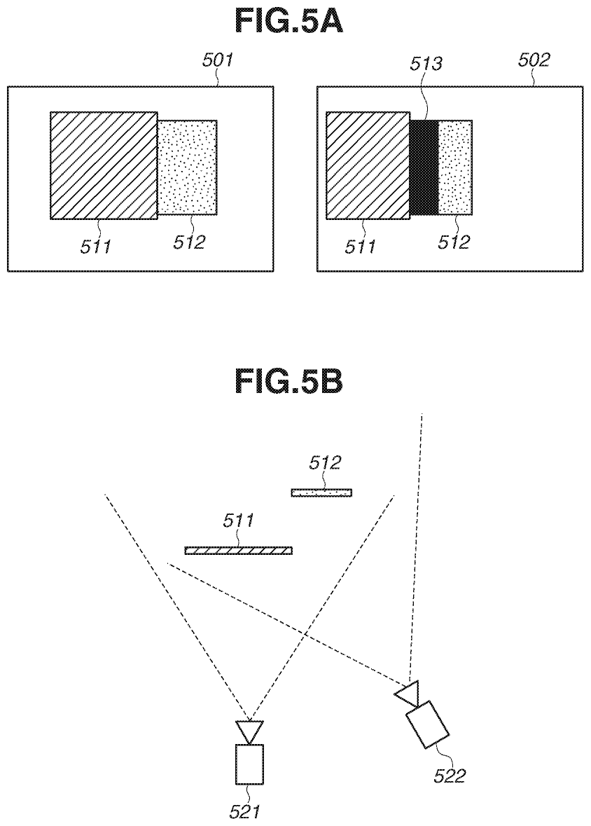

Initially, an outline of general reprojection processing performed based on the latest position and orientation will be described with reference to FIGS. 5A and 5B. In a rendered image 501 depicting two virtual objects 511 and 512, it is assumed that the virtual object 511 is located closer to a viewpoint and the virtual object 512 is located farther from the viewpoint.

In the reprojection processing, initially, the virtual objects are back-projected, based on the depth image, to positions in a three-dimensional space as viewed from a position and orientation 521 at a time of rendering. FIG. 5B illustrates a state in which the three-dimensional space is viewed from above, and the virtual object 511 illustrated in FIG. 5B is a result of back-projecting the virtual object 511 illustrated in FIG. 5A. The virtual object 512 illustrated in FIG. 5B is a result of back-projecting the virtual object 512 illustrated in FIG. 5A. In a case where the virtual objects are reprojected so as to be viewed from the latest position and orientation 522, a rendered image 502 is generated. At this time, a hole region 513 occurs in the vicinity of a boundary between the two virtual objects 511 and 512. In one or more embodiments, reprojection processing is performed on a per-polygon basis to prevent generation of the hole region.

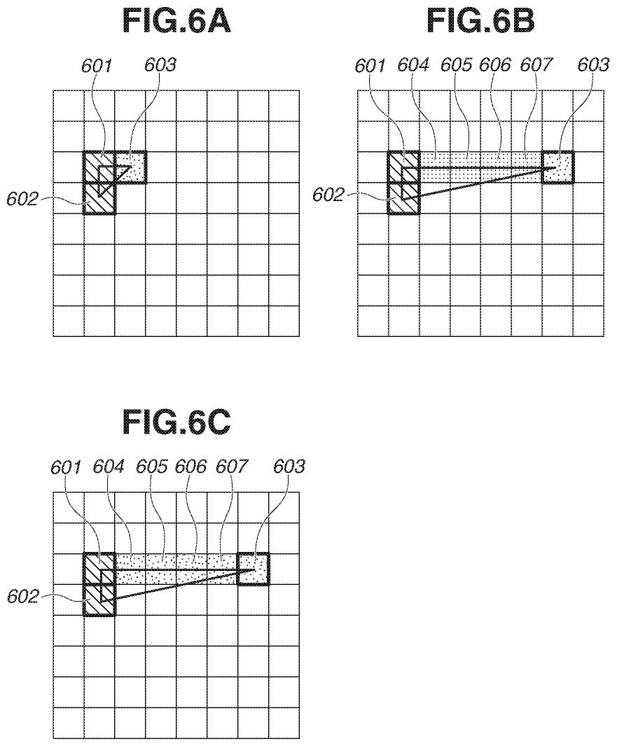

In the reprojection processing of step S403, a polygon mesh is generated on the image by treating each pixel of the image as a vertex, and reprojection processing is performed on a per-polygon basis. Then, a color inside the polygon is determined based on a vertex farthest from the viewpoint among vertices constituting the polygon. An outline of a method for determining colors inside the mesh in one or more embodiments will be described below with reference to FIGS. 6A to 6C. In one or more embodiments, description is provided assuming that the polygon is a triangle. The shape of the polygon is not limited thereto, and, for example, the polygon may be a quadrilateral in one or more embodiments.

First, consider a polygon including three pixels 601, 602, and 603 as illustrated in FIG. 6A. Here, the pixels 601 and 602 belong to the same virtual object, and the pixel 603 belongs to a different virtual object. It is assumed that the pixels 601, 602, and 603 are arranged as illustrated in FIG. 6B based on the depth image and the motion information. Four pixels 604 to 607 in FIG. 6B represent pixels inside this polygon.

In one or more embodiments, a color for the pixels 604 to 607 inside the polygon is determined based on a farthest pixel among the pixels 601, 602, and 603 corresponding to vertices constituting the polygon.

For example, it is assumed that depth values of the pixels 601 and 602 in the depth image are 0.5 and a depth value of the pixel 603 is 0.7. Since a larger depth value means that the pixel is located farther from the viewpoint, the pixel 603 is the farthest pixel among the pixels 601, 602, and 603. Accordingly, as illustrated in FIG. 6C, it is determined that the pixels 604 to 607 are interpolated with the color of the pixel 603.

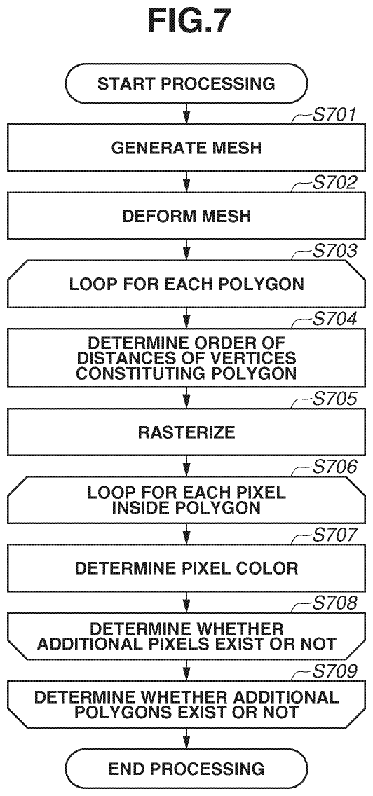

FIG. 7 is a flowchart illustrating an example of a detailed processing procedure of the reprojection processing performed in step S403 in one or more embodiments. The reprojection processing in step S403 will be described below with reference to FIG. 7.

In step S701, the mesh generation unit 311 generates a mesh based on the rendered image generated in step S401. In one or more embodiments, the mesh generation unit 311 generates the mesh with each pixel of the rendered image being treated as a vertex and connecting the vertices to form triangular polygons.

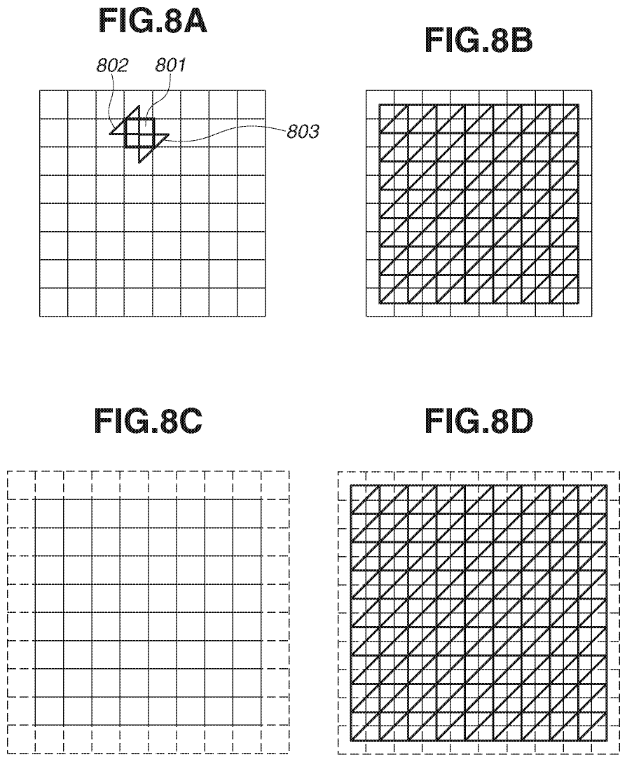

A method for generating the mesh will be described with reference to FIGS. 8A to 8D. FIG. 8A illustrates a rendered image. In one or more embodiments, for each pixel, the mesh generation unit 311 generates two polygons: a polygon that connects the pixel to a left pixel and an upper pixel, and a polygon that connects the pixel to a right pixel and a lower pixel. For a pixel 801 illustrated in FIG. 8A, the mesh generation unit 311 generates a polygon 802 connecting the pixel 801 to the left pixel and the upper pixel and a polygon 803 connecting the pixel 801 to the right pixel and the lower pixel. The mesh generation unit 311 performs this processing for all pixels, thus generating a mesh as illustrated in FIG. 8B.

Next, in step S702, the mesh deformation unit 312 deforms the mesh generated in step S701 based on the depth image generated in step S401 and the position and orientation information of the HMD 101 acquired in step S402. In this processing, after back-projecting each vertex constituting the mesh into a three-dimensional space, the mesh deformation unit 312 moves the position of the vertex in the three-dimensional space based on the position and orientation information of the HMD. Then, by reprojecting the vertex into a two-dimensional space, the mesh deformation unit 312 obtains a destination position of the vertex in the two-dimensional space and deforms the mesh based on the destination position.

A position of each vertex of the mesh is represented by coordinates of a corresponding pixel on a rendered image. First, by performing an inverse viewport transformation on coordinates (x, y) of each vertex constituting the mesh according to Equations (1) below, the mesh deformation unit 312 inversely converts the coordinates into coordinates (x_{NDC}, y_{NDC}, z_{NDC}) in the three-dimensional space. Then, by performing an inverse projection transformation according to Equation (2), the mesh deformation unit 312 calculates coordinates P_{camera} as a result of the inverse-projection.

$${x}_{NDC} = 2. * \frac{x + 0.5}{width} - 1. \\ {y}_{NDC} = 2. * \frac{y + 0.5}{height} - 1. \\ {z}_{NDC} = depth ( x , y ) \qquad ( 1 )$$

In Equations (1), width represents a resolution in a width direction of the rendered image, height represents a resolution in a height direction of the rendered image, and depth (x, y) represents a depth value at coordinates (x, y). In Equation (2), Prj⁻¹ represents an inverse matrix of a perspective projection transformation matrix Prj.

Next, based on two pieces of position and orientation information, namely, position and orientation information of the HMD 101 used for rendering and latest position and orientation information immediately before performing the reprojection processing, the mesh deformation unit 312 moves the position of the vertex in the three-dimensional space using Equation (3) below and calculates coordinates P′_{camera} after the movement.

$${P}_{camera}^{′} = {View}_{new} * {View}_{old}^{- 1} * {P}_{camera} \qquad ( 3 )$$

In Equation (3), View_{new} represents the latest position and orientation immediately before the reprojection processing, and View_{old}⁻¹ represents an inverse transformation of the position and orientation used for rendering.

Subsequently, for the coordinates after the movement, the mesh deformation unit 312 performs projection transformation according to Equation (4) below, w-division according to Equation (5), and a viewport transformation according to Equations (6), thereby reprojecting the coordinates into two-dimensional coordinates (x′, y′).

$${P}_{camera} = {Prj}^{- 1} * ( \begin{matrix}{x}_{NDC} \\ {y}_{NDC} \\ {z}_{NDC} \\ 1.\end{matrix} ) \qquad ( 2 )$$

The mesh deformation unit 312 performs this processing for all vertices constituting the mesh to obtain destination positions of the vertices of the mesh in the two-dimensional coordinates, and the mesh deformation unit 312 deforms the mesh based on the destination positions of the vertices.

The processing operations in steps S703 to S709 are repeatedly executed for all polygons of the deformed mesh. For instance, in and after step S703, a loop of steps S704-S705, and a subloop of steps S706-S708, is performed for each polygon. In step S706, step S707 is looped or repeatedly performed for each pixel inside of each of the polygons. In step S708, it is determined whether another pixel exists in the polygon being processed, the another pixel being a pixel for which step S707 has not been performed. If “YES”, then step S707 is performed for the another pixel. If “NO”, then it is determined in step S709 whether another polygon exists for which steps S703-S708 have not been performed. If “YES”, then steps S703-S708 are repeated for the another polygon and then step S709 is repeated until it is determined that no other polygon exists (“NO” in response to step S709). If “NO”, then processing is ended.

In step S704, the distance determination unit 313 determines an order of vertices constituting a polygon to be processed in descending order of distances in a depth direction from the viewpoint. In the deformed mesh, the distance in the depth direction from the viewpoint is determined based on a z-coordinate (z′NDC) calculated using Equation (5).

In step S705, the determination unit 314 performs rasterization to identify pixels inside the polygon to be processed. The rasterization may be implemented, for example, by obtaining a bounding box circumscribing the polygon and performing an inside/outside determination using an edge function for pixels inside the bounding box. Since the edge function is a known technique, description thereof is omitted. The rasterization method is not limited to this method.

The processing operations in steps S706 to S708 are repeatedly executed for all pixels inside the polygon to be processed that are identified in step S705.

In step S707, the determination unit 314 determines a color for a pixel to be processed based on the order of the distances determined in step S704. Specifically, the determination unit 314 determines the color for the pixel to be processed to be a color of a vertex having the highest distance order, that is, a vertex located farthest from the viewpoint.

As described above, according to one or more embodiments, to generate a polygon mesh on an image with each pixel of the image treated as a vertex and to perform reprojection processing on a per-polygon basis, the color inside the polygon is determined based on a vertex located farthest from the viewpoint among vertices constituting the polygon. This enables reduction of the occurrence of gradation-like artifacts resulting from reprojection processing using the mesh.

### One or More Additional Embodiments

In the aforementioned one or more embodiments, a method has been described in which, among vertices constituting a polygon, a vertex farthest from the viewpoint is determined and a color inside the polygon is determined based on the color of the vertex. In contrast, in a case where a translucent object is placed in a region in which nothing exists, a plurality of pixels may overlap for a translucent pixel, so that a depth value may become infinite and the depth value may fail to be uniquely defined. As a result, in the above-described hole region for one or more embodiments, it may be difficult or impossible to uniquely determine the color inside the polygon, and hole filling processing may fail to be successfully performed in some cases.

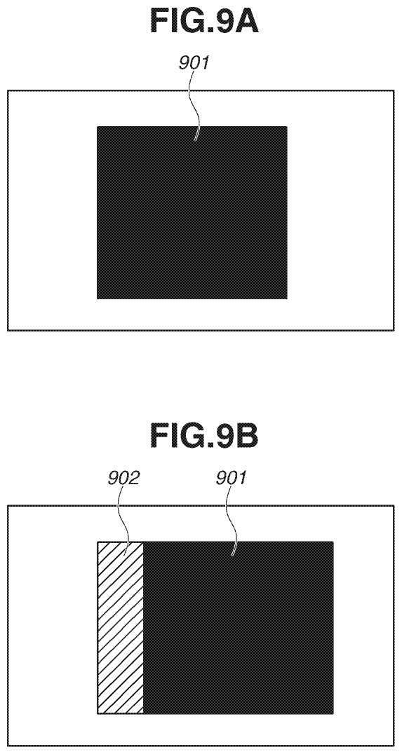

An embodiment example in which the color inside the polygon cannot be uniquely determined will be described with reference to FIGS. 9A and 9B. FIG. 9A illustrates an embodiment example in which a translucent object 901 is placed in a region in which nothing exists. Since nothing exists behind the translucent object 901, a depth value in the region becomes infinite.

It is assumed that, as a result of the reprojection processing, the translucent object 901 is positioned as illustrated in FIG. 9B. At this time, since all vertices of a polygon that connects a boundary between the translucent object 901 and the surrounding region in which nothing exists are located at infinity, a vertex located farthest from the viewpoint cannot be uniquely determined. Accordingly, with the method described in the first embodiment, the color inside the polygon cannot be uniquely determined, and the color for a region 902 in FIG. 9B becomes indeterminate, resulting in unsuccessful hole filling processing.

In view of this, in one or more embodiments, description is provided of a method for determining a color inside a polygon based on transparency in addition to determining whether a vertex is located farthest from the viewpoint. Description will be provided focusing on differences from one or more embodiments described above, and description of similar points is omitted.

### (Functional Configuration(s) of Image Processing Apparatuses)

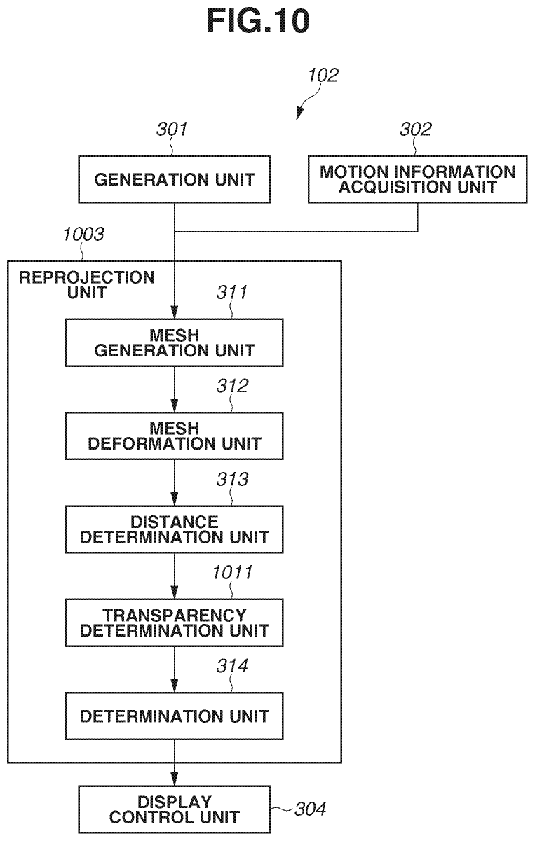

FIG. 10 is a block diagram illustrating an embodiment example of a functional configuration of the image processing apparatus 102 in accordance with one or more aspects of the present disclosure. In addition to the configuration illustrated in FIG. 3 in one or more embodiments, a reprojection unit 1003, which corresponds to the reprojection unit 303, of the image processing apparatus 102 further includes a transparency determination unit 1011. The other configurations are similar to those in FIG. 3, so that description thereof is omitted.

The transparency determination unit 1011 determines, in each polygon constituting a mesh deformed by the mesh deformation unit 312, an order of vertices constituting the polygon in descending order of transparency. Here, transparency is expressed as a numerical value in a range from 0 to 1, and a value closer to 0 indicates higher opacity.

### (Processing Executed by One or More Image Processing Apparatuses)

Since the overall processing of one or more embodiments is basically similar to that of FIG. 4 described in the aforementioned one or more embodiments, description thereof is omitted. In one or more embodiments, a detailed processing procedure of the reprojection processing in step S403 differs from that in one or more of the aforementioned embodiments, and thus will be described below.

### (Details of Reprojection Processing in Step S403 for One or More Embodiments)

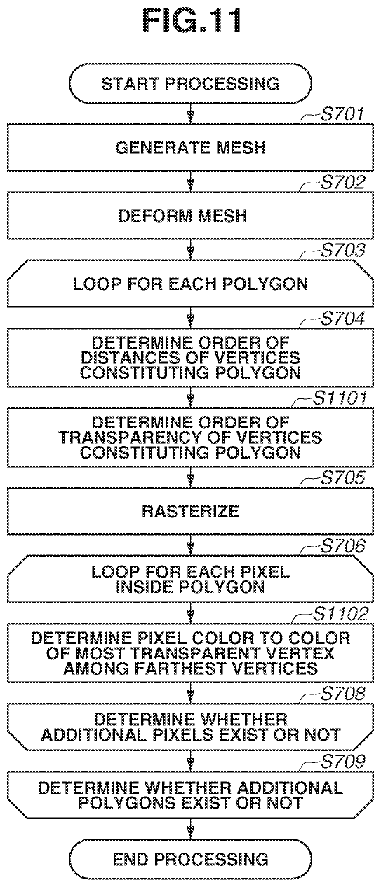

FIG. 11 is a flowchart illustrating an example of a detailed processing procedure of the reprojection processing in step S403 of FIG. 4, in one or more embodiments. The reprojection processing in step S403 in one or more embodiments will be described below with reference to FIG. 11. Steps S701 to S704, S705, S706, S708, and S709 in FIG. 11 are similar to steps S701 to S704, S705, S706, S708, and S709 in FIG. 7 described in one or more of the aforementioned embodiments, and thus description thereof is omitted.

In step S1101, the transparency determination unit 1011 determines an order of vertices constituting a polygon to be processed in descending order of transparency.

In step S1102, the determination unit 314 determines a color for a pixel to be processed to be the color of a vertex having the highest transparency among vertices having the greatest distance from the viewpoint, where the transparency is determined in step S1101 and the order of the distances are determined in step S704. For example, in a region in which nothing exists, transparency has the maximum value of 1. Accordingly, in a polygon including a vertex pixel in the region in which nothing exists, the determination unit 314 determines the color for the pixel to be processed to be the color of the vertex pixel of the region in which nothing exists.

As described above, according to one or more embodiments, a color inside a polygon may be uniquely determined even at a boundary between a translucent region and an infinite-distance region. This enables reduction of the occurrence of gradation-like artifacts resulting from reprojection processing using the mesh even in a case where a translucent object is included.

### One or More Additional Embodiments

In one or more of the aforementioned embodiments, reprojection processing has been described in which position and orientation information of the HMD is used as motion information. However, a motion vector of CG may be used as the motion information. For example, a motion vector may be obtained by an application from an amount of movement of a vertex in normalized device coordinates between a previous frame and a current frame. A method for obtaining the motion vector is not limited to this, and the motion vector may be obtained from optical flow between images, for example.

In a case where a motion vector of CG is used as motion information, a method for calculating a destination position of each vertex in two-dimensional coordinates in the mesh deformation processing of step S702 will be described. First, the mesh deformation unit 312 performs the inverse viewport transformation according to Equations (1) described above on coordinates (x, y) of a vertex constituting the mesh, thus inversely converting the coordinates into coordinates (x_{NDC}, y_{NDC}, z_{NDC}) in a three-dimensional space.

Next, the mesh deformation unit 312 moves the vertex using a motion vector according to Equations (7) below and calculates coordinates (x′NDC, y′NDC, z′NDC) after the movement.

x′_{NDC}=x_{NDC}+motion(x,y)ₓ

y′_{NDC}=y_{NDC}+motion(x,y)_{y}

z′_{NDC}=z_{NDC}+motion(x,y)_{z}

In Equations (7), the term motion (x, y)ₓ represents an amount of movement in an x direction at coordinates (x, y). The term motion (x, y)_{y} represents an amount of movement in a y direction at coordinates (x, y). The term motion (x, y)_{z} represents an amount of movement in a z direction at coordinates (x, y).

Then, the mesh deformation unit 312 performs the viewport transformation according to Equations (6) described above on the coordinates after the movement to reproject the coordinates into two-dimensional coordinates (x′, y′). Reprojection processing using, as motion information, position and orientation information of the HMD and reprojection processing using a motion vector may be performed in parallel.

In one or more of the aforementioned embodiments, the procedure described in conjunction with FIGS. 8A and 8B has been described as a method for generating a mesh in step S701, but the method for generating the mesh is not limited to this example.

For example, as illustrated in a dotted-line region in FIG. 8C, the rendered image may be expanded outward by one pixel, and as illustrated in FIG. 8D, a mesh may be generated by generating polygons for all pixels, including the expanded pixels.

In one or more of the aforementioned embodiments, a method for determining the color for a pixel inside a polygon in the reprojection processing has been described. However, as a result of the polygons being moved by the reprojection processing, polygons may overlap and a plurality of polygons may exist for the same pixel. In such a case, a frontmost determination based on depth values of the polygons may be performed, and the color may be determined using a result of processing performed on a polygon located foremost. In that case, the depth value may be determined, for example, by linear interpolation based on distances from vertices constituting the polygon.

In one or more of the aforementioned embodiments, a method has been described in which the color inside the polygon is determined to be the color of a vertex located farthest from the viewpoint among vertices constituting a polygon. However, the color determination method is not limited to this. For example, a color for a pixel on an edge may be determined to be the color of a vertex located farthest from the viewpoint among vertices constituting the edge.

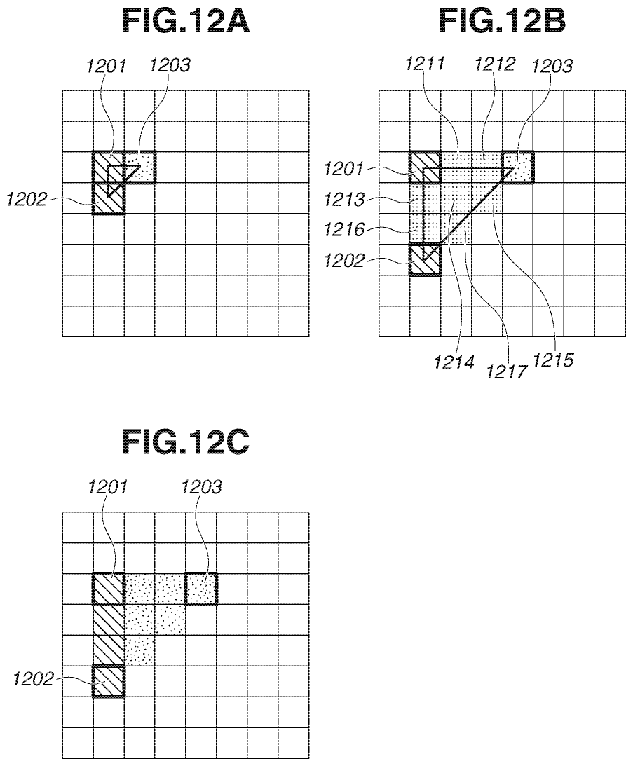

This method will be described with reference to FIGS. 12A to 12C.

First, consider a polygon including three pixels 1201, 1202, and 1203 as illustrated in FIG. 12A. Here, the pixels 1201 and 1202 belong to the same virtual object, and the pixel 1203 belongs to another virtual object. Further, it is assumed that the pixel 1203 has the largest depth value, and the pixels 1201 and 1202 have depth values smaller than the depth value of the pixel 1203 and have the same depth value as each other. It is assumed that the pixels 1201, 1202, and 1203 are arranged as illustrated in FIG. 12B based on the depth image and the motion information. Seven pixels 1211 to 1217 in FIG. 12B represent pixels inside this polygon.

In this case, the pixels 1211 and 1212 are located on an edge that connects vertices corresponding to the pixel 1201 and the pixel 1203, so that colors for the pixels 1211 and 1212 are determined to be the color of a pixel farther from the viewpoint between the pixel 1201 and the pixel 1203 (in this case, the pixel 1203). Similarly, the pixels 1213 and 1216 are located on an edge that connects vertices corresponding to the pixel 1201 and the pixel 1202, so that colors for the pixels 1213 and 1216 are determined to be the color of the pixel 1201 (1202). Further, the pixels 1215 and 1217 are located on an edge that connects vertices corresponding to the pixel 1202 and the pixel 1203, so that colors for the pixels 1215 and 1217 are determined to be the color of the pixel 1203 that is farther from the viewpoint. On the other hand, the pixel 1214 exists inside the polygon rather than on an edge, so that a color for the pixel 1214 is determined to be the color of the pixel 1203 that is farthest from the viewpoint among vertices constituting the polygon. As a result, the configuration illustrated in FIG. 12C is obtained.

A similar color determination method may also be employed in one or more additional embodiments. For example, in FIG. 12A, it is assumed that the pixels 1201 and 1202 belong to a region in which nothing exists, have transparency of 1, and the pixel 1203 belongs to a translucent object and has transparency of 0.5.

In a case where the pixels 1201 to 1203 are arranged as illustrated in FIG. 12B, the pixels 1201 to 1203 have infinite depth values, so that a vertex located farthest from the viewpoint cannot be uniquely determined. Accordingly, for example, for the pixels 1211 and 1212, the colors are determined to be the color of a pixel having higher transparency between the pixel 1201 and the pixel 1203 (in this case, the pixel 1201). Further, the pixel 1214 exists inside the polygon rather than on an edge, so that the color for the pixel 1214 is determined to be the color of a pixel having the highest transparency among vertices constituting the polygon.

The present disclosure may also be implemented by supplying, via a network or a storage medium, a program for implementing one or more functions of the embodiments described above to a system or an apparatus, and causing one or more processors of a computer of the system or the apparatus to read and execute the program. The present disclosure may also be implemented by a circuit (e.g., an application specific integrated circuit (ASIC)) for implementing one or more functions.

### Other Embodiments

Embodiment(s) of the present disclosure may also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to, and the benefit of, Japanese Patent Application No. 2025-073256, filed Apr. 25, 2025, which is hereby incorporated by reference herein in its entirety.

1. An image processing apparatus that performs reprojection processing on a rendered image obtained by rendering an image of a virtual object, to correct a positional misalignment based on a depth image in which a depth value representing a distance from a viewpoint in the rendered image is embedded and based on motion information at the viewpoint, the image processing apparatus comprising:
one or more processors that operate to:
generate a mesh including a plurality of polygons each having pixels of the rendered image as vertices;
deform, in accordance with the reprojection processing, the generated mesh based on the depth image and the motion information;
determine, for each vertex of a respective polygon of the plurality of polygons of the deformed mesh, a distance from the viewpoint to the vertex; and
determine a color for each pixel inside a respective polygon of the plurality of polygons of the deformed mesh, based on the determined distances from the viewpoint to vertices of the respective polygon.

2. The image processing apparatus according to claim 1, wherein the one or more processors further operates to determine the color for each pixel inside the respective polygon of the plurality of polygons of the deformed mesh based on a color of a vertex having a greatest distance from the viewpoint among vertices of the respective polygon, the distances being determined by the one or more processors.

3. The image processing apparatus according to claim 1, wherein the one or more processors further operate to:
determine a transparency for each vertex of a respective polygon of the plurality of polygons of the deformed mesh; and
determine the color for each pixel inside the respective polygon of the plurality of polygons of the deformed mesh, based on the determined distances from the viewpoint to the vertices of the respective polygon and the determined transparency at the vertices of the respective polygon.

4. The image processing apparatus according to claim 3, wherein the one or more processors further operate to determine the color for each pixel inside the respective polygon of the plurality of polygons of the deformed mesh, based on a color of a vertex having the greatest transparency, determined by the one or more processors, among the vertices of the respective polygon having the greatest distance from the viewpoint, determined by the one or more processors.

5. The image processing apparatus according to claim 3, wherein the one or more processors further operate to determine a color for each pixel located on an edge of a respective polygon of the plurality of polygons of the deformed mesh based on a color of a vertex having a higher transparency than a transparency of another vertex among vertices forming the edge, determined by the one or more processors.

6. The image processing apparatus according to claim 5, wherein the one or more processors further operate to determine the color for each pixel located inside the respective polygon of the plurality of polygons of the deformed mesh and not located on an edge of the respective polygon, based on a color of a vertex having a highest transparency, determined by the one or more processors, among vertices that constitute the respective polygon.

7. The image processing apparatus according to claim 1, wherein the one or more processors further operate to determine a color for each pixel located on an edge of a respective polygon of the plurality of polygons of the deformed mesh, based on a color of a vertex having a greater distance from the viewpoint than a distance of another vertex from the viewpoint among vertices forming the edge, the distances being determined by the one or more processors.

8. The image processing apparatus according to claim 7, wherein the one or more processors further operates to determine the color for each pixel located inside the respective polygon of the plurality of polygons of the deformed mesh and not located on an edge of the respective polygon, based on a color of a vertex of the respective polygon having a greatest distance from the viewpoint, the greatest distance being determined by the one or more processors, among vertices that constitute the respective polygon.

9. The image processing apparatus according to claim 1, wherein the one or more processors further operate to:
acquire, as the motion information, position and orientation information for the viewpoint more recent than position and orientation information for the viewpoint used at a time of generating the rendered image; and
deform the generated mesh based on the depth image and the acquired position and orientation information.

10. The image processing apparatus according to claim 1, wherein the one or more processors further operate to:
acquire, as the motion information, a motion vector of the virtual object; and
deform the generated mesh based on the depth image and the acquired motion vector.

11. The image processing apparatus according to claim 1, wherein the one or more processors further operate to output, to a display, an image on which the reprojection processing has been performed using the determined colors.

12. An image processing method for performing reprojection processing on a rendered image obtained by rendering an image of a virtual object, to correct a positional misalignment based on a depth image in which a depth value representing a distance from a viewpoint in the rendered image is embedded and based on motion information at the viewpoint, the image processing method comprising:
generating a mesh including a plurality of polygons each having pixels of the rendered image as vertices;
deforming, in accordance with the reprojection processing, the mesh generated in the generating based on the depth image and the motion information;
first determining, for each vertex of a respective polygon of the plurality of polygons of the mesh deformed in the deforming, a distance from the viewpoint to the vertex; and
second determining a color for each pixel inside a respective polygon of the plurality of polygons of the deformed mesh, based on distances from the viewpoint to vertices of the respective polygon determined in the first determining.

13. A non-transitory computer-readable medium storing a program that causes a computer to perform an image processing method for performing reprojection processing on a rendered image obtained by rendering an image of a virtual object, to correct a positional misalignment based on a depth image in which a depth value representing a distance from a viewpoint in the rendered image is embedded and based on motion information at the viewpoint, the image processing method comprising:
generating a mesh including a plurality of polygons each having pixels of the rendered image as vertices;
deforming, in accordance with the reprojection processing, the mesh generated in the generating based on the depth image and the motion information;
first determining, for each vertex of a respective polygon of the plurality of polygons of the mesh deformed in the deforming, a distance from the viewpoint to the vertex; and
second determining a color for each pixel inside a respective polygon of the plurality of polygons of the deformed mesh, based on distances from the viewpoint to vertices of the respective polygon determined in the first determining.
